(19) United States
(12) Patent Application Publication
(10) Pub. No.: US 2011/0087745 A1
(43) Pub. Date: Apr. 14, 2011

(54) GROUP VOTING ACCESS CONTROL FOR MULTI-PARTY FORUMS

(75) Inventors: PATRICK J. O'SULLIVAN, DUBLIN (IE); LIAM HARPUR, Dublin (IE); BARRY E. WILLNER, Briarcliff Manor, NY (US); EDITH H. STERN, YORKTOWN HEIGHTS, NY (US)

(73) Assignee: INTERNATIONAL BUSINESS MACHINES CORPORATION, ARMONK, NY (US)

(21) Appl. No.: 12/578,755

(22) Filed: Oct. 14, 2009

(51) Int. Cl. G06F 15/16

(52) U.S. Cl. 709/206; 709/204; 709/225

(57) ABSTRACT

Group access control for a multi-party forum that includes receiving by a server a request from a party to access a multi-party forum, forwarding by the server the request to an approval group comprising at least two people, and approving or a denying the request by the server based on receiving votes from at least two persons of the approval group.

### BACKGROUND

Aspects of the present invention relate to access to multi-party forums, and more specifically to group voting access control for multi-party forums.

Currently, it is common for an invitation to be sent out to an individual granting them access to a meeting or other multi-party forum such as an Instant Messaging (IM) chat. Likewise, it is often the case where an individual is allowed access to a team room. In both of the above examples, the invitation/access to the multi-party forum is usually granted by one person. One person granting access to a multi-party forum (e.g., to team rooms, multi-party IM meetings, etc.) is a bottleneck, can cause many problems and is less efficient. For example, the usual person who grants access may not be available resulting in valuable time being wasted. Also, one individual may make an error, e.g., an inappropriate individual may be invited thus causing a potential business risk for loosing confidential/sensitive information. Further, when one individual makes an arbitrary decision it may alienate others related to the multi-party forum.

### BRIEF SUMMARY

According to one aspect of the present invention, a method, operable on a server, for group access control for a multi-party forum that includes receiving by the server a request from a party to access a multi-party forum, forwarding by the server the request to an approval group comprising at least two people, and approving or a denying the request by the server based on receiving votes from at least two persons of the approval group.

According to another aspect of the present invention, a computing device for differential message security policies includes an interface, the interface being configured to receive a request from a party to access a multiparty forum and forward the request to an approval group comprising at least two people, and a processor, the processor configured to approve or a deny the request based on receiving votes from at least two persons of the approval group.

According to a further aspect of the present invention, a computer program product includes a computer readable storage medium having computer readable program code embodied therewith, the computer readable storage medium including computer readable program code configured to receive a request from a party to access a multi-party forum, computer readable program code configured to forward the request to an approval group comprising at least two people, and computer readable program code configured to approve or deny the request based on receiving votes from at least two persons of the approval group.

### BRIEF DESCRIPTION OF THE DRAWINGS

Aspects of the present invention are further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for group access control for a multiparty forum according to an exemplary embodiment of the present invention;

FIG. 2 is a flowchart of a process for group access control for a multiparty forum according to an exemplary embodiment of the present invention;

FIG. 3 is a flowchart of a process for group access control for a multiparty forum according to another exemplary embodiment of the present invention; and

FIG. 4 is a flowchart of a process for group access control for a multiparty forum according to a still further exemplary embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention may be implemented on a server and provide the capability for a group of persons to have access control to multi-party forums. A group gives more flexibility and failover capability for situations where the usual person who grants access is not available thus preventing valuable time from being wasted. A group decision is more accurate overall reducing the risk of one individual making an error by granting access to an inappropriate individual causing a potential business risk for loosing confidential/sensitive information. In addition, a group decision is more inclusive and better for teamwork preventing one individual from making an arbitrary decision that may alienate the group.

Embodiments according to the present invention provide the ability to grant and revoke access to multiparty forums such as, for example, IM chats, team rooms, wikis, data/information resources (e.g., libraries), etc. using group voting. Rather than only one person granting access to a multiparty forum, the existing attendees of a multiparty forum or members of a voting approval group can vote whether to include a proposed invitee or person requesting access to the multiparty forum. Approval may be based on any of many types of criteria that may be set such as, for example, the invitee receiving a majority of the votes (i.e., 50% or greater approval) or the invitee may be required to obtain a unanimous vote where all members must vote to approve the invitee.

The voting mechanism according to embodiments of the present invention may also be skewed hierarchically. For example, for access to a multiparty forum, certain voting members may have more voting weight than other voting members. For example, a vote of a manager may have a higher weight assigned to his vote than that assigned to a lower level employee. In other embodiments of the present invention, voting may be policy driven, for example, a policy may define that two votes and the invitee is in (e.g., requires 1 nomination and 1 seconded), two-thirds majority and the invitee is in, etc.

If the voting mechanism is based on weighted voting, various criteria may be taken into consideration in determining how a particular user's vote may be weighted. For example, a user's vote may be weighted based on a position of the user in an organization, based on using a social network graph (where the more a voting member knows the invitee, the more weight may be assigned to the voting member's vote), a member's vote may be skewed on the basis of a voting member's contribution (e.g., if an individual has contributed more to a multiparty room then the individual's vote may be more heavily weighted), a vote weighting based on a contribution made by the voting member (where a person that has contributed or is related more to the multiparty forum may have their vote weighed more, or for example, a person that has multiple publications in a publication forum or a higher education in a job multiparty forum, or more experience based on the type of forum, etc. may have a higher weighted vote), vote weighting based on activity (where any voting member that has a more temporal/proximity relationship with the invitee (e.g., recent exchange) may have a higher weighted vote), or if the voting member has had more recent experience with the multiparty forum or the subject of the multiparty forum, etc.)

In addition, according to embodiments of the present invention, voting may be differentially allowed depending on who the proposed attendee/requestee is. For example, external people desiring access to the multiparty forum may be subject to voting because of some confidentiality concerns. According to embodiments of the present invention, an interested party (e.g., a moderator or a person/entity with the relevant authority such as a policy implemented by the business) may be allowed to enable and configure and impose multiparty forum group voting access control functionality. For example, a business may stipulate that meeting invites that contain external individuals are to be subject to the voting functionality. Group voting access control for multiparty forums according to embodiments of the present invention provide more flexibility and failover capability for handling access to a multiparty forum. Further, for some collaborations the social response possible via voting is more appropriate. In addition, the possibility of error is reduced such as, for example, one individual making an error to admit an invitee. With group voting, a decision is likely to be more accurate overall. In addition, there is a greater sense of teamwork and cohesiveness as a group decision is likely to be more inclusive and better for teamwork.

According to embodiments of the present invention, an application that provides group voting access control for multiparty forums may be based on a proposed invitee's profile. In this regard, specific details regarding the invitee/requestor may be taken into consideration by the voting members to grant approval or denial to access to the multiparty forum. Further, access to the multiparty forum containing sensitive information may require greater safeguards before an invitee is admitted. Moreover, in embodiments according to the present invention, an individual may not be allowed to vote for a proposed invitee if there is deemed to be a potential conflict between a voting member and the invitee such as, for example, both the voting member and the proposed invitee are in the same department.

According to embodiments of the present invention, voters may be required to sign a digital receipt to confirm their identity before their vote is counted. As noted previously, voters may also vote to give differential rights to an invitee/requestor such as, for example, some invitees may receive restricted access and other invitees may have complete access to the multiparty forum. For example, according to embodiments of the present invention, sensitive information in a multiparty forum (e.g., IM chat or team room) may be kept invisible for some users who are voted into the multiparty forum. In addition, the voting members may vote on a generic or personalized invitation for access to a multiparty forum. A generic invitation to a multiparty forum may simply be a simple forum that is the same for all requesting parties. In contrast, a personalized invitation to a multiparty forum may be an invitation that is a tailored request from a requesting person sent to the voting members of the group.

In addition according to embodiments of the present invention, a chairperson/business may specify that group voting is to be employed to vote individuals in or out of the multiparty forum when the chairperson/business is configuring a meeting, team room, or other type of multiparty forum or related resource. Voting may be differentially handled such as, for example, persons invited or desiring access to a multiparty forum that are more senior than a second line manager may not be subject to the voting safeguard (i.e., allowed access without a vote). Further, an individual may request access to a resource/multiparty forum then the group may vote. Alternatively, the group may vote on inviting users before any requests have been received for the multiparty forum. According to some embodiments of the present invention, details of the vote may be kept anonymous. In other embodiments, an applicant may be apprised of the details of vote. Further, it may be required that for denying access, the analysis of the vote indicate one or more of simple majority, two-thirds majority, any three people, any one person, etc.

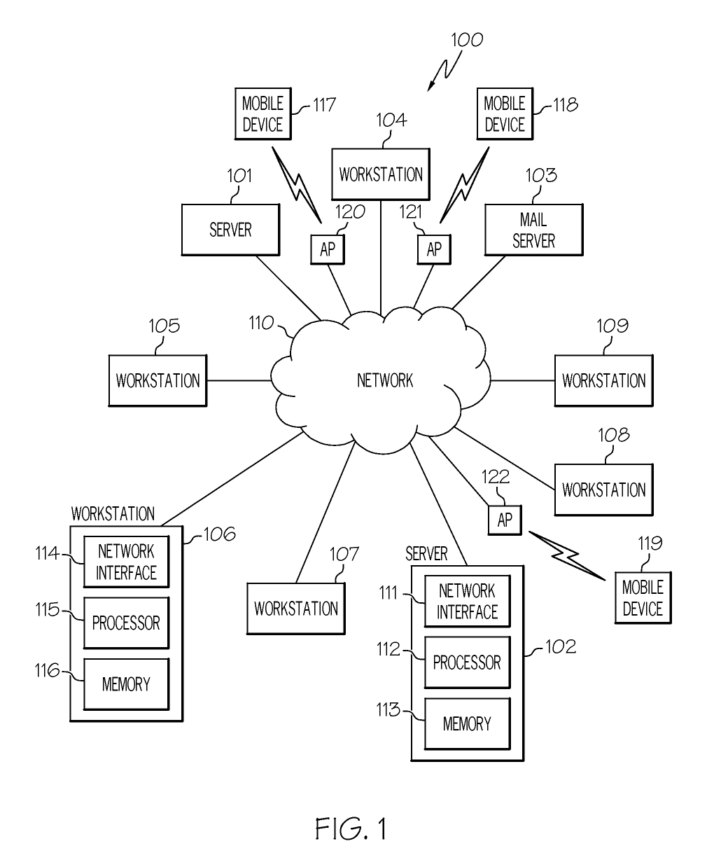

FIG. 1 shows a diagram of a system for group access control for a multiparty forum according to an exemplary embodiment of the present invention. A system 100 may include one or more servers 101, 102, one or more mail servers 103, one or more wireless devices 117-119, and one or more workstations 104-109, where the servers 101, 102, wireless devices 117-119, and workstations 104-109 may be interconnected via a network 110. The wireless devices 117-119 may access the network 110 via one or more access points 120-122 or by any other method. The wireless devices 117-119 may be any type of wireless device such as, for example, a mobile phone, a personal digital assistant (PDA), a portable game system, a laptop computer, etc. The network 110 may be the Internet, an intranet, a local area network, a wide area network, or any other type of network. Each server 101, 102, 103 may include a network interface 111, a processor 112, a memory 113, and other elements normally associated with a server. Similarly, each workstation 104-109 may include a network interface 114, a processor 115, and memory 116, and other items normally associated with a workstation.

A processor 112 of each server 101, 102, 103 or a processor 115 of each workstation 104-109 may be configured to approve or deny the request based on receiving votes from at least two persons of the approval group. A network interface 111 of each server 101, 102, 103 or a network interface 114 of each workstation 104-109 may be configured to receive a request from a party to access a multiparty forum and forward the request to an approval group comprising at least two people. A processor 112 of each server 101, 102, 103 or a processor 115 of each workstation 104-109 may also be configured to weigh the votes from the at least two persons of the approval group based on one or more of an organizational position of each at least two persons of the approval group, a social network position of each at least two persons of the approval group, a contribution of each at least two persons of the approval group, a date of a last activity each at least two persons of the approval group, and a date of a first activity each at least two persons of the approval group. A processor 112 of each server 101, 102, 103 or a processor 115 of each workstation 104-109 may further be configured to receive signed digital receipt from each of the multiple people of the approval group to confirm their identity.

A processor 112 of each server 101, 102, 103 or a processor 115 of each workstation 104-109 may further be configured to a profile of a requesting party to the approval group. A processor 112 of each server 101, 102, 103 or a processor 115 of each workstation 104-109 may further be configured to not allow one or more persons of the approval group to vote based on a potential conflict between the party and the one or more persons of the approval group. A processor 112 of each server 101, 102, 103 or a processor 115 of each workstation 104-109 may further be configured to receive votes from the approval group giving differential rights to the party where the party has restricted access to the forum. A processor 112 of each server 101, 102, 103 or a processor 115 of each workstation 104-109 may further be configured to receive one of an approval or a denial for a group of people including the party for access to the forum before receiving the request from the party to access the forum.

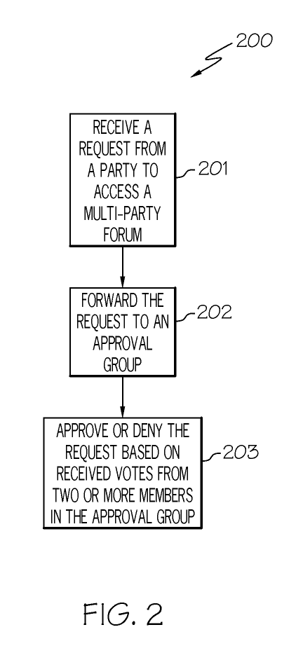

FIG. 2 shows a flowchart of a process for group access control for multiparty forums according to an exemplary embodiment of the present invention. In the process 200, in block 201, a request from a party may be received to access the forum. In block 202, the request may be forwarded to an approval group. The approval group may consist of two or more members. In block 203, approval or denial of the request may be decided based on votes received from two or more persons in the approval group.

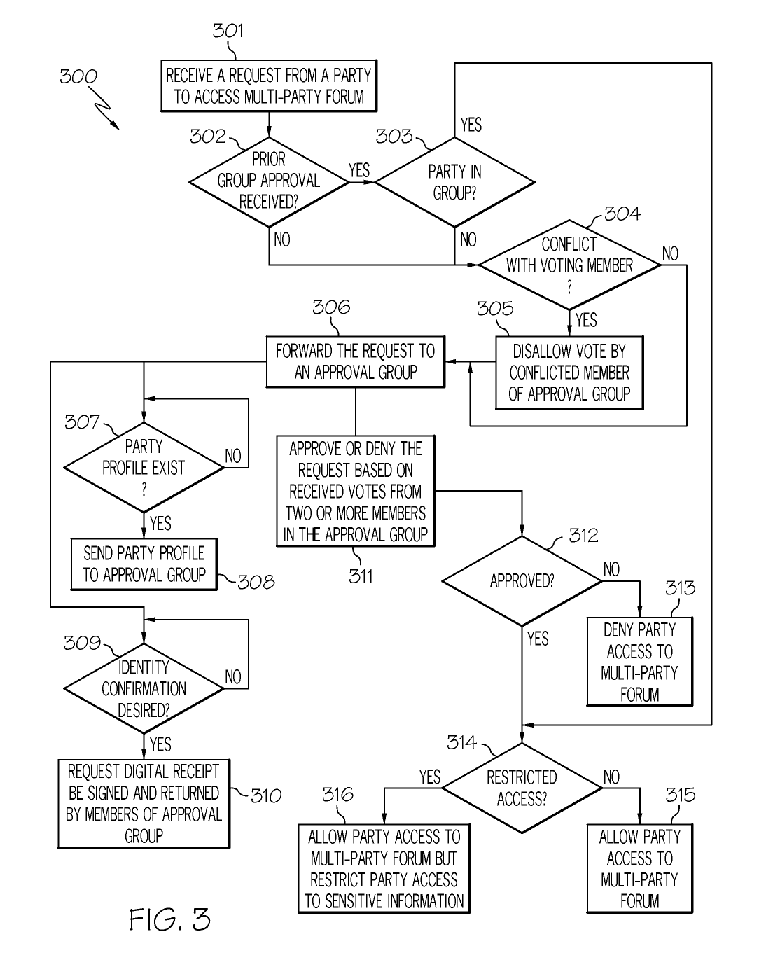

FIG. 3 shows a flowchart of a process for group access control for multiparty forums according to another exemplary embodiment of the present invention. In the process 300, in block 301, a request may be received from a party to access the multiparty forum. In block 302, it may be decided whether prior group approval has been received and if so, in block 303, it may be determined if the requesting party is in the approved group. If the party is in the approved group, then in block 314, it may be determined whether the party has a restricted access and if not, then in block 315, the party may be allowed access to the multiparty forum. If the party has a restricted access approval then in block 316, the party may be allowed access to the multiparty forum but restricted from access to sensitive information.

If there is no prior group approval or if the party is not in an approved group, then in block 304, it may be determined whether there is a conflict with the requesting party and an existing voting member and if not, then in block 307, a request is forwarded to the members of the approval group. If there is a conflict with the requesting parties and one or more members of the approval group then in block 306, the votes by any conflicting members of the approval group will not be counted and disallowed. The in block 306, the request may be forwarded to the members of the approval group.

In block 307, it may be determined if a profile exists for the requesting party. The profile may include information regarding the requesting party including demographic information such as age, gender, job title, location, etc. and other types of information. If no party profile information exists, no further actions are taken regarding a party profile. If a party profile exists, then in block 308 the party profile may be sent to the members of the approval group for consideration in their voting. Further, after forwarding the request to the members of the approval group, in block 309 it may be determined if identity confirmation is desired of the voting members, and if so, then in block 310, a request may be sent that a digital receipt be signed and returned by all voting members of the approval group.

After the members have voted, in block 311, the votes from two or more members in the approval group may be received. Then in block 312, it may be determined if the party's request has been approved and if not, in block 313, the party may be denied access to the multiparty forum. If the party's request has been approved, then in block 314, it may be determined whether the party has received a restricted access approval and if not, then in block 315, the party may be allowed access to the multiparty forum. If the party has received a restricted access to the multiparty forum, then in block 316, the party may be allowed access to the multiparty forum but restricted from access to sensitive information.

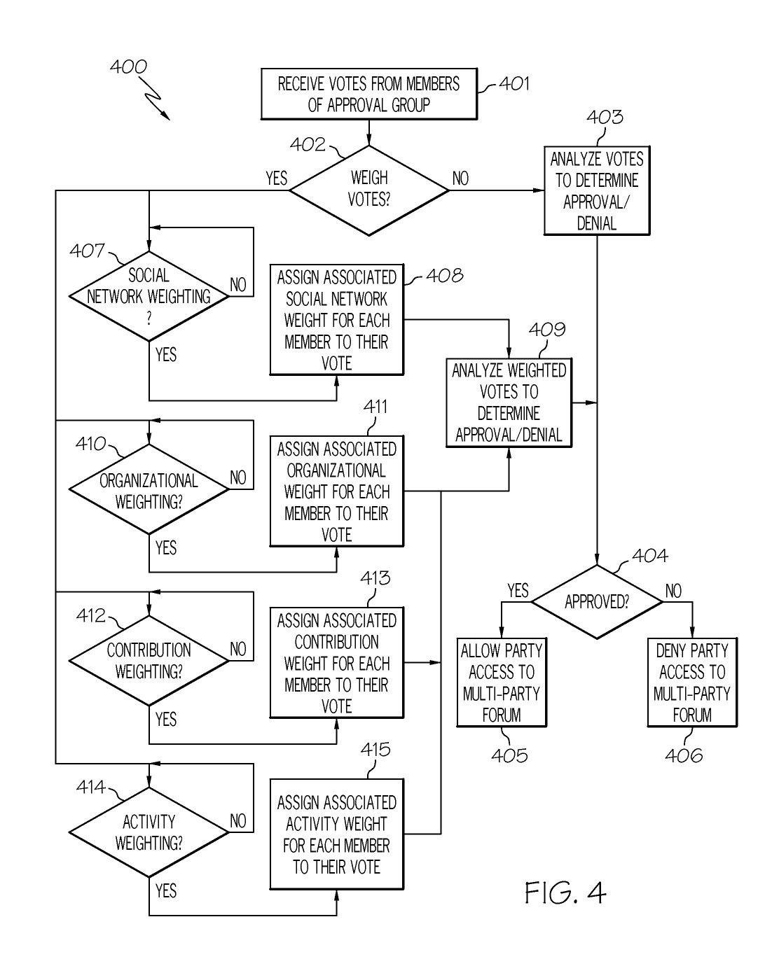

FIG. 4 shows a flowchart of a process for group access control or multiparty forums according to a still further exemplary embodiment of the present invention. In the process 400, in block 401, votes may be received from members of an approval group that approves access to a multiparty forum. In block 402, it may be determined if the votes are weighted. If the votes are not weighted, then in block 403, the votes may be analyzed to determine approval or denial of access to the multiparty forum. Then in block 404, it may be determined if access has been approved and if not, then in block 406, a requesting party may be denied access to the multiparty forum. If the approval has been granted, then in block 405, the requesting party may be allowed access to the multiparty forum.

If in block 402 it is determined that the votes are weighted, then it may be determined which one of many types of weighting has been applied to the votes for members of the approval group. A voting member may have one or more different weighting factors assigned to their vote for a particular multiparty forum. For example, in block 407 it may be determined if social network weighting has been applied and if so, then in block 408, an associated social network weight for each member may be assigned to their vote. A social network weight may be for example giving a voting member's vote more weight if the voting member knows the party well and giving a voting member's vote less weight the less the voting member may know of the requesting party. A voting member that may live in the same area, be a member of a same organization, or have other ties to the requesting member may be given more weight for their vote. Then in block 409 the weighted votes may be analyzed to calculate the votes for approval or denial of access to the multiparty room. In block 404, it may be determined if access has been approved and if not then in block 406 a requesting party may be denied access to the multiparty forum. If the approval has been granted, then in block 405, the requesting party may be allowed access to the multiparty forum.

Further, in block 410, it may be determined that organizational weighting has been applied to the members' votes and if so, then in block 411, the associated organization weight for each member may be assigned to their vote. Then in block 409 the weighted votes may be analyzed to calculate the votes for approval or denial of access to the multiparty room. In block 404, it may be determined if access has been approved and if not then in block 406 a requesting party may be denied access to the multiparty forum. If the approval has been granted, then in block 405, the requesting party may be allowed access to the multiparty forum.

In addition, in block 412, it may be determined if contribution weighting is assigned to the votes and if so, then in block 413, an associated contribution weight for each member may be assigned to their vote. Contribution weighting may be for example, giving a voting member more weight to their vote if that voting member has made more contributions than other voting members to the subject matter or purpose of the multiparty forum. For example, if the multiparty forum is a forum with a library of publications, a voting member that has a large number of their own publications may be given a higher weighted vote. In another example, if the multiparty forum is a job fair forum, a person that is a voting member that has a higher education or more experience related to the types of jobs offered, may have their votes weighted more than other voting members. Then in block 409 the weighted votes may be analyzed to calculate the votes for approval or denial of access to the multiparty room. In block 404, it may be determined if access has been approved and if not then in block 406 a requesting party may be denied access to the multiparty forum. If the approval has been granted, then in block 405, the requesting party may be allowed access to the multiparty forum.

In block 414, it may be determined whether activity weighting is being assigned and if so, then in block 415, an associated activity weight for each member will be assigned to their vote. For example, a voting member who has more subject matter knowledge of the particular multiparty forum may be given more weight to their vote, or a voting member that has more temporal/proximity relationship with the person requesting access (e.g., recent exchange) may have a higher weighted vote for access to the particular forum. Then in block 409 the weighted votes may be analyzed to calculate the votes for approval or denial of access to the multiparty room. In block 404, it may be determined if access has been approved and if not then in block 406 a requesting party may be denied access to the multiparty forum. If the approval has been granted, then in block 405, the requesting party may be allowed access to the multiparty forum.

According to embodiments of the present invention, voting by the voting members may also be used to revoke permission to a multiparty forum that has already been granted. In this embodiment, the voting process may occur as mentioned previously except that the members vote to revoke permission as opposed to approve access to a multiparty forum.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method, operable on a server, for group access control for a multi-party forum comprising:
receiving by the server a request from a party to access a multi-party forum;
forwarding by the server the request to an approval group comprising at least two people; and
computing an answer to the request by the server based on receiving votes from at least two persons of the approval group.

2. The method according to claim 1, further comprising sending by the server a profile of the party to the approval group.

3. The method according to claim 1, further comprising preventing by the server a person of the approval group from voting based on a potential conflict between the party and the person of the approval group.

4. The method according to claim 1, further comprising receiving by the server a signed digital receipt from the at least two people of the approval group to confirm their identity.

5. The method according to claim 1, further comprising receiving by the server votes from the approval group giving differential rights to the party giving the party only restricted access to the forum.

6. The method according to claim 5, wherein the restricted access comprises the party not having access to sensitive information.

7. The method according to claim 1, further comprising receiving by the server votes for one of a generic and a personalized invitation approval from the approval group.

8. The method according to claim 1, wherein the forum comprises one of a multi-party Instant Messaging (IM) chat room, a team room forum, and a collaborative resource forum.

9. The method according to claim 1, wherein the votes from the at least two persons of the approval group are weighted based on one of an organizational position of each person of the approval group, a social network position of each person of the approval group, a contribution of each person of the approval group, and a date of an activity of each person of the approval group.

10. The method according to claim 1, further comprising receiving by the server votes for one of an approval or a denial for a group of people including the party for access to the forum before receiving the request from the party to access the forum.

11. A computing device for differential message security policies comprising:
an interface, the interface being configured to receive a request from a party to access a multiparty forum and forward the request to an approval group comprising at least two people; and
a processor, the processor configured to compute an answer to the request based on receiving votes from at least two persons of the approval group.

12. The computing device according to claim 11, further comprising the received votes being based on a profile of the party.

13. The computing device according to claim 11, further comprising the processor preventing a person of the approval group from being allowed to vote based on a potential conflict between the party and the person of the approval group.

14. The computing device according to claim 11, further comprising the interface receiving a signed digital receipt from each of the multiple people of the approval group to confirm their identity.

15. The computing device according to claim 11, wherein the forum comprises one of a multi-party Instant Messaging (IM) chat room, a team room forum, and a collaborative resource forum.

16. The computing device according to claim 11, wherein the votes from the at least two persons of the approval group are weighted based on one of an organizational position of each person of the approval group, a social network position of each person of the approval group, a contribution of each person of the approval group, a date of an activity of each person of the approval group.

17. A computer program product comprising a computer readable storage medium having computer readable program code embodied therewith, the computer readable storage medium comprising:
computer readable program code configured to receive a request from a party to access a multi-party forum;
computer readable program code configured to forward the request to an approval group comprising at least two people; and
computer readable program code configured to compute an answer to the request based on received votes from at least two persons of the approval group.

18. The computer program product according to claim 17, further comprising computer readable program code configured to not allow a person of the approval group from voting based on a potential conflict between the party and the person of the approval group

19. The computer program product according to claim 17, wherein the forum comprises one of a multi-party Instant Messaging (IM) chat room, a team room forum, and a collaborative resource forum.

20. The computer program product according to claim 17, wherein the votes from the at least two persons of the approval group are weighted based on one of an organizational position of each person of the approval group, a social network position of each person of the approval group, a contribution of each person of the approval group, a date of an activity of each person of the approval group.
